(19) United States
(12) Patent Application Publication
(10) Pub. No.: US 2026/0287141 A1
(43) Pub. Date: Sep. 24, 2026

(54) ROTATABLE BULB AND BULB GROUP

(71) Applicant: SAVANT TECHNOLOGIES LLC, East Cleveland, OH (US)

(72) Inventors: Jie GAO, Shanghai (CN); Hai HUANG, Shanghai (CN); Chunxiao GAO, Shanghai (CN)

(73) Assignee: SAVANT TECHNOLOGIES LLC, East Cleveland, OH (US)

(21) Appl. No.: 19/557,948

(22) Filed: Mar. 5, 2026

(30) Foreign Application Priority Data
Mar. 21, 2025 (CN) 202520511371X

(51) Int. Cl. F21V 1/10; F21V 17/12

(52) U.S. Cl. CPC F21V 1/10; F21V 17/12

(57) ABSTRACT

Provided is a rotatable bulb that includes a lampshade having a lampshade body portion and a lampshade connection portion located at the bottom of the lampshade body portion, a light-emitting element, a driving unit electrically connected to the light-emitting element, and a base being connected to the lampshade connection portion by means of a connection housing for electrically connecting the rotatable bulb to a socket, the light-emitting element being arranged in an inner space of the lampshade, the connection housing and/or the base, the connection housing being connected between the lampshade and the base, and the lampshade connection portion being rotatable relative to the connection housing so that a user can manually adjust the rotation angle of the lampshade of the rotatable bulb relative to the base, and can fit the rotatable bulb to various sockets as required.

### CROSS-REFERENCE TO RELATED APPLICATION

This application claims priority to Chinese Patent Application Serial Number 202520511371.X, filed March 21, 2025, which is herein incorporated by reference.

### DESCRIPTION

### Technical Field

The present utility model relates to the field of lamps, and in particular, to a rotatable bulb and a bulb group.

### BACKGROUND

In the field of lamps, the lampshade is usually fixed and the rotation angle cannot be adjusted after the bulb is installed to the socket. Therefore, the use flexibility of such bulbs is relatively limited, and especially for bulbs with special shapes such as flat bulbs, if the lampshade of the bulb cannot be rotated relative to the socket, its better appearance can only be seen in a specific direction.

### SUMMARY

In order to overcome the described defect existing in the prior art, the present utility model provides a rotatable bulb, comprising: a lampshade, the lampshade comprising a lampshade body portion and a lampshade connection portion located at the bottom of the lampshade body portion; a light-emitting element; a driving unit, the driving unit being electrically connected to the light-emitting element; and a base, the base being connected to the lampshade connection portion by means of a connection housing for electrically connecting the rotatable bulb to a socket, the light-emitting element being arranged in an inner space of the lampshade, the connection housing and/or the base, the connection housing being connected between the lampshade and the base, and the lampshade connection portion being rotatable relative to the connection housing. Accordingly, the user can manually adjust the rotation angle of the lampshade of the rotatable bulb of the present utility model relative to the base so as to satisfy different usage requirements, and can fit the rotatable bulb to various sockets as required.

Further, the lampshade connection portion comprises an inner annular hook formed at the bottom thereof, and the connection housing comprises an outer annular hook formed at the top thereof, wherein in a state in which the lampshade is connected to the connection housing, the inner annular hook is located on the inner side of the outer annular hook in the radial direction and is snap-fitted with the outer annular hook. Accordingly, the convenience of connection between the lampshade and the connection housing can be improved.

Further, the lampshade connection portion further comprises a limiting protrusion extending from the bottom of the lampshade connection portion towards the top of the connection housing, and the connection housing further comprises a limiting boss extending from the top of the connection housing, wherein in a state in which the lampshade is connected to the connection housing, the limiting protrusion abuts against the top of the connection housing and the limiting boss abuts against the bottom of the lampshade connection portion. Accordingly, the in-position connection between the lampshade and the connection housing can be conveniently ensured.

Further, the connection housing further comprises at least one damping adjustment boss formed at the top thereof, the at least one damping adjustment boss is arranged on the inner side of the outer annular hook in the radial direction, and in a state in which the lampshade is connected to the connection housing, the inner annular hook is clamped between the outer annular hook and the at least one damping adjustment boss. Accordingly, the operational feeling of the user when rotating the lampshade can be improved, and it is convenient for the user to rotate the lampshade to a desired angle more accurately.

Further, the lampshade connection portion comprises an outer annular hook formed at the bottom thereof, and the connection housing comprises an inner annular hook formed at the top thereof, wherein in a state in which the lampshade is connected to the connection housing, the inner annular hook is located on the inner side of the outer annular hook in the radial direction and is snap-fitted with the outer annular hook. Accordingly, the convenience of connection between the lampshade and the connection housing can be improved.

Further, the connection housing comprises a tubular body and a top cover connected to the top of the tubular body, the top cover being centrally provided with a central opening; and the lampshade connection portion comprises a connection post extending centrally from the bottom of the lampshade connection portion towards the connection housing, a central through-hole opening towards the connection housing being formed in the connection post; and the lampshade is connected to the connection housing by means of a fastening mechanism, the fastening mechanism comprising a fastener, wherein in a state in which the lampshade is connected to the connection housing, the connection post extends to the interior of the connection housing through the central opening, and the fastener is fastened into the central through-hole. Accordingly, the convenience of connection between the lampshade and the connection housing can be improved.

Further, the fastening mechanism further comprises a damping washer with an opening, and the damping washer is clamped between a head of the fastener and the connection post and abuts against the top cover. Accordingly, the operational feeling of the user when rotating the lampshade can be improved, and it is convenient for the user to rotate the lampshade to a desired angle more accurately.

Further, the fastener is a screw. Accordingly, the manufacturing cost can be reduced.

Further, the screw is a self-tapping screw; or the connection post forms an internal thread in the central through-hole, and the internal thread is fitted with an external thread of the screw. Accordingly, the manufacture and operation can be facilitated.

Further, the top cover is connected to the tubular body by means of at least one radial rib. Accordingly, the manufacture can be facilitated and the product weight can be reduced.

Further, the connection housing comprises an annular groove formed on a top surface of the top cover and opening towards the lampshade connection portion, and the lampshade connection portion comprises a guide member extending from the bottom of the lampshade connection portion towards the top cover, wherein in a state in which the lampshade is connected to the connection housing, the guide member is received into the annular groove. Accordingly, the positioning accuracy of the lampshade and the connection housing can be improved.

Further, the lampshade connection portion comprises an inner annular flange extending from the bottom of the lampshade connection portion towards the connection housing, and the connection housing comprises an outer annular flange formed at the top of the tubular body and extending towards the lampshade, wherein in a state in which the lampshade is connected to the connection housing, the inner annular flange is located on the inner side of the outer annular flange in the radial direction and abuts against the outer annular flange in a shape-fitting manner. Accordingly, the positioning accuracy of the lampshade and the connection housing can be further improved.

Further, the light-emitting element is a filament, and the filament is arranged around the lampshade body portion. Accordingly, the cost can be reduced and the bulb is more aesthetically pleasing.

Further, the driving unit is arranged in the base. Further, a tapered or cylindrical space is formed in the base, and the driving unit is arranged in the space. Accordingly, the driving unit can be better hidden, such that the bulb is more aesthetically pleasing.

Further, the driving unit is arranged at an interface between the base and the lampshade connection portion. Accordingly, a balance between the appearance of the bulb and the convenience of connection between the driving unit and the light-emitting element can be achieved.

Further, the driving unit is arranged in the lampshade connection portion. Further, a tapered or cylindrical space is formed in the lampshade connection portion, and the driving unit is arranged in the space. Accordingly, the convenience of connection between the driving unit and the light-emitting element can be improved.

In addition, the present utility model further provides a bulb group, comprising a plurality of rotatable bulbs, the plurality of rotatable bulbs being rotatable to specific angles respectively as required. Accordingly, the appearance and the user customizability of the bulb group can be improved.

### BRIEF DESCRIPTION OF THE DRAWINGS

The drawings are used for providing further understanding of the present utility model, and constitute a part of the present utility model. The schematic embodiments of the present utility model and the illustrations thereof are used for explaining the present utility model, and do not constitute improper limitations to the present utility model. In the drawings:

FIG. 1 is a schematic perspective view of a rotatable bulb according to a first embodiment of the present utility model;

FIG. 2 is a schematic exploded view of a rotatable bulb shown in FIG. 1;

FIG. 3 is a sectional perspective view of a part of a rotatable bulb shown in FIG. 1;

FIG. 4 is a schematic exploded view of a rotatable bulb according to a second embodiment of the present utility model;

FIG. 5 is a side sectional view of a part of a rotatable bulb shown in FIG. 3; and

FIG. 6 is a schematic exploded view of a rotatable bulb according to a third embodiment of the present utility model.

### DETAILED DESCRIPTION OF THE EMBODIMENTS

The following describes the technical solutions in the embodiments of the present utility model in detail with reference to the drawings in the embodiments of the present utility model. It should be noted that the embodiments of the present utility model and the features in the embodiments can be combined with each other without conflicts.

In the following detailed description, reference is made to the drawings which form a part of the specification, and the specific embodiments in which the present utility model can be practiced are shown by way of example illustration. Directional terms, such as "top", "bottom", "inner", "outer", "upper", "lower", "front" and "rear", with respect to the drawings, are used with reference to the direction of the drawings being described. As components of the embodiments of the present utility model may be placed in many different directions, the directional terms are used for purposes of illustration only and are not intended to be limiting. It is to be understood that other embodiments may be utilized and structural or logical changes may be made without departing from the scope of the present utility model. Therefore, the following detailed description should not be understood as limiting, and the present utility model is defined by the appended claims.

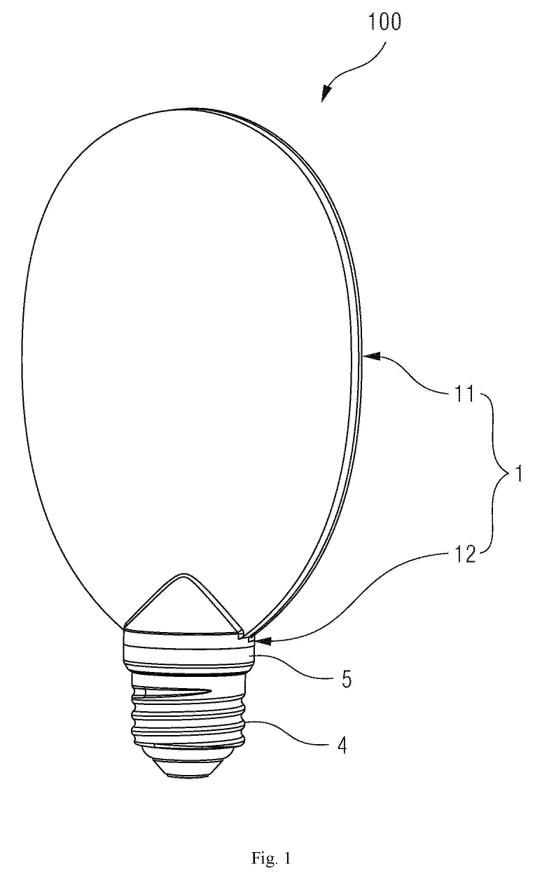

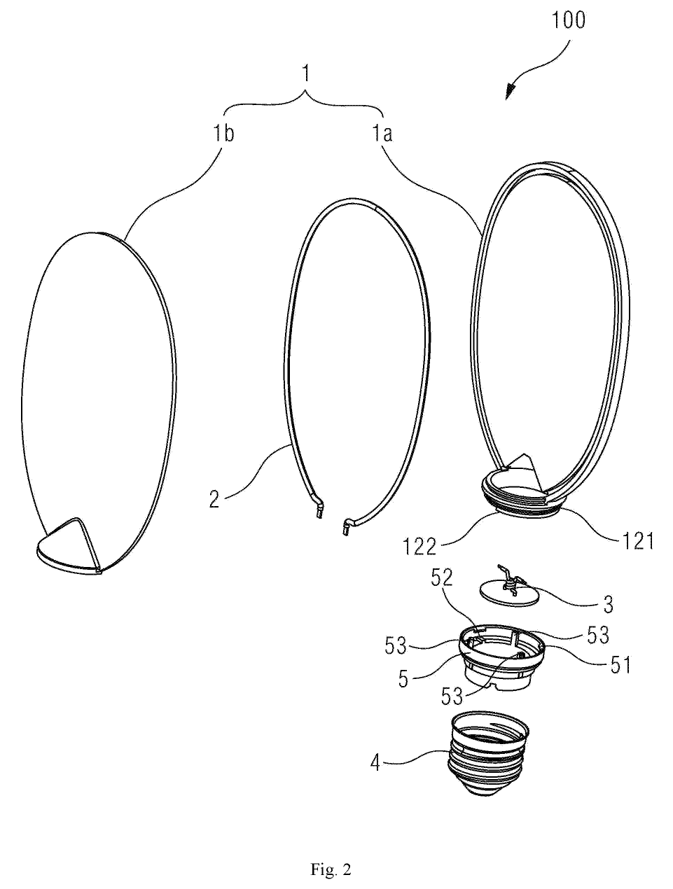

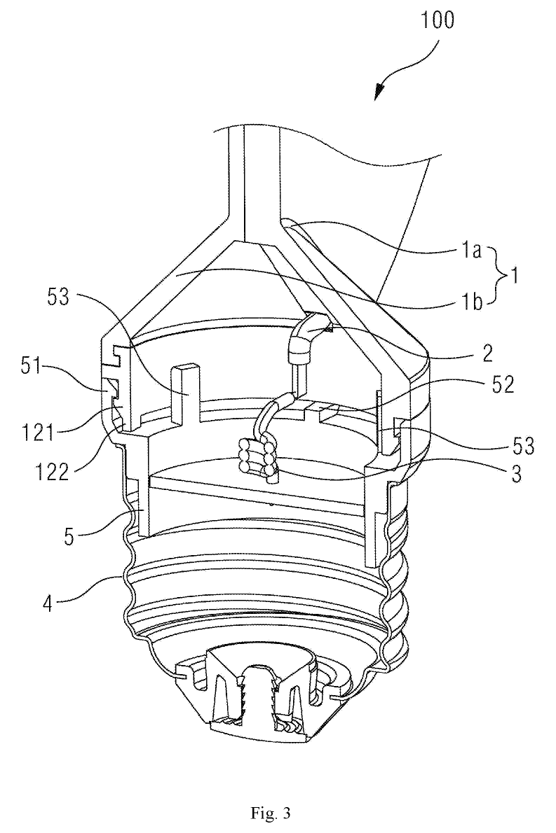

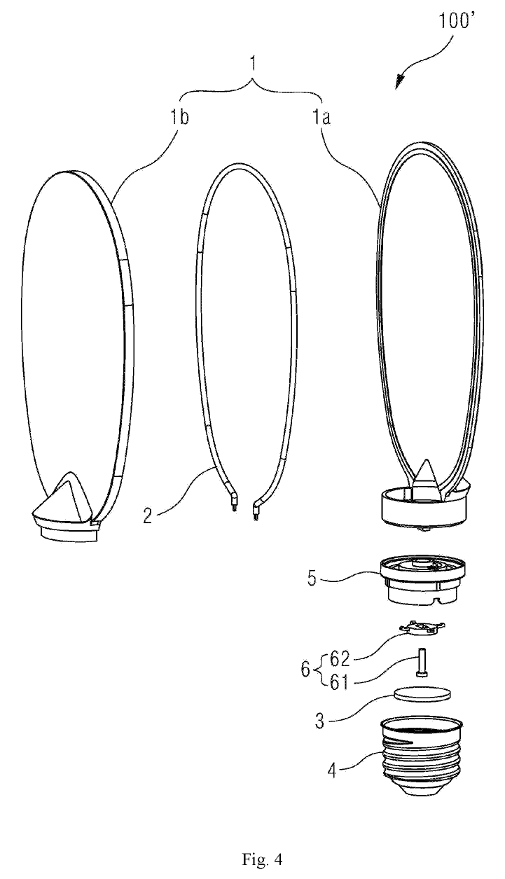

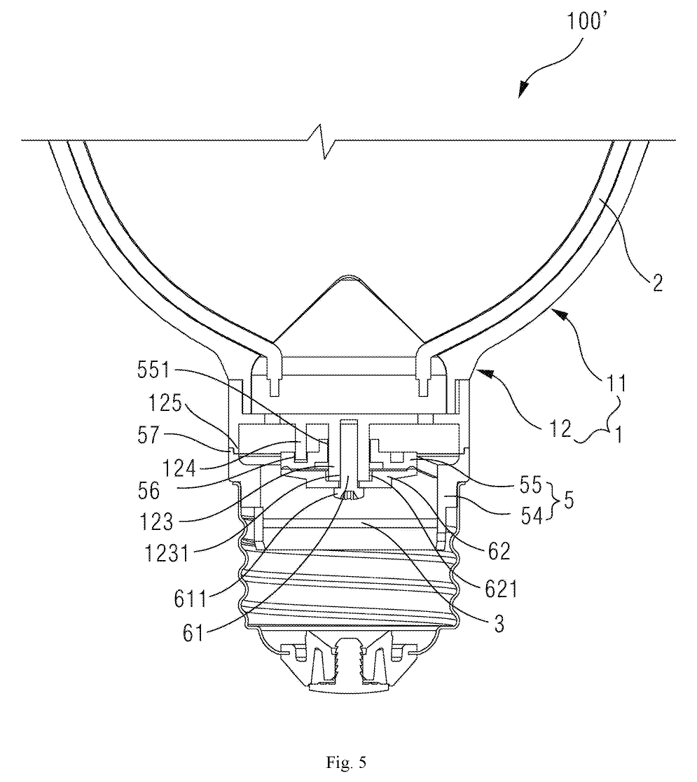

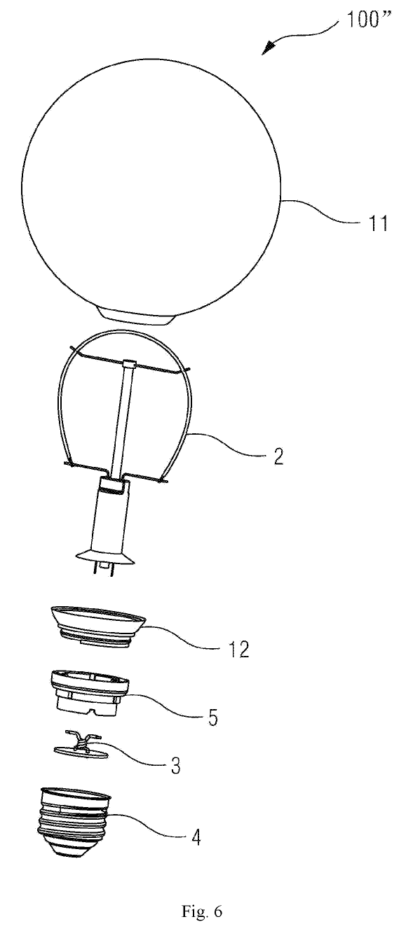

The present utility model provides a rotatable bulb. FIGS. 1 to 3 show a rotatable bulb 100 according to a first embodiment of the present utility model, FIGS. 4 to 5 show a rotatable bulb 100' according to a second embodiment of the present utility model, and FIG. 6 shows a rotatable bulb 100" according to a third embodiment of the present utility model, wherein the rotatable bulbs in the first embodiment and the second embodiment have substantially the same structure except the specific structures of the lampshade connection portion and the connection housing, and the rotatable bulbs in the first embodiment and the third embodiment also have substantially the same structure except the specific structures of the lampshade and the light-emitting element.

The rotatable bulb may generally comprise a lampshade 1, a light-emitting element 2, a driving unit 3 and a base 4.

The lampshade 1 may comprise a lampshade body portion 11 and a lampshade connection portion 12 located at the bottom of the lampshade body portion 11. In particular, the lampshade body portion 11 and the lampshade connection portion 12 may be integrally formed, or may be separately manufactured and connected together, for example, by glue or ultrasonic welding. Further, at least a part of the lampshade body portion 11 may have a flat shape, as shown in the first embodiment shown in FIGS. 1 to 3 and the second embodiment shown in FIGS. 4 to 5, or may have a conventional spherical shape, as shown in the third embodiment shown in FIG. 6. Of course, the form of the lampshade is not limited thereto. The light-emitting element 2 may be arranged in an inner space of the lampshade 1, the connection housing 5 and/or the base 4. These inner spaces of the rotatable bulb, i.e. the inner space of the lampshade 1, the inner space of the connection housing 5 and the inner space of the base 4, can communicate with one another to form an integral inner space, and the light-emitting element 2 can actually be arranged at any position in this inner space. Preferably, the light-emitting element 2 may be arranged in an inner space of the lampshade 1. In particular, the light-emitting element 2 may be a filament or other light-emitting structure, for example, in the case that the light-emitting element 2 is a filament, the filament may be arranged around the lampshade body portion 11. The driving unit 3 may be electrically connected to the light-emitting element 2. The base 4 may be connected to the lampshade connection portion 12 by means of a connection housing 5 for electrically connecting the rotatable bulb to a socket. The connection housing 5 may be connected between the lampshade 1 and the base 4, and the lampshade connection portion 12 is rotatable relative to the connection housing 5. The rotatable bulb of the present utility model is particularly suitable for bulbs in the form of flat bulbs or the like.

For example, in the first embodiment shown in FIGS. 1 to 3, the lampshade connection portion 12 may comprise an inner annular hook 121 formed at the bottom thereof, and the connection housing 5 may comprise an outer annular hook 51 formed at the top thereof. In a state in which the lampshade 1 is connected to the connection housing 5, the inner annular hook 121 is located on the inner side of the outer annular hook 51 in the radial direction and is snap-fitted with the outer annular hook 51. Of course, the connection manner between the lampshade connection portion 12 and the connection housing 5 is not limited thereto, and they may be connected to each other in any manner as long as rotation can be achieved.

Further, the lampshade connection portion 12 may further comprise a limiting protrusion 122 extending from the bottom of the lampshade connection portion towards the top of the connection housing 5, and the connection housing 5 may further comprise a limiting boss 52 extending from the top of the connection housing 5. In a state in which the lampshade 1 is connected to the connection housing 5, the limiting protrusion 122 abuts against the top of the connection housing 5 and the limiting boss 52 abuts against the bottom of the lampshade connection portion 12.

Further, the connection housing 5 may further comprise at least one damping adjustment boss 53 formed at the top thereof, the at least one damping adjustment boss 53 is arranged on the inner side of the outer annular hook 51 in the radial direction, and in a state in which the lampshade 1 is connected to the connection housing 5, the inner annular hook 121 is clamped between the outer annular hook 51 and the at least one damping adjustment boss 53.

Alternatively, the radial positions of the inner annular hook 121 and the outer annular hook 51 can be reversed. In other words, the lampshade connection portion 12 may comprise an outer annular hook formed at the bottom thereof, and the connection housing 5 may comprise an inner annular hook formed at the top thereof. In a state in which the lampshade 1 is connected to the connection housing 5, the inner annular hook is located on the inner side of the outer annular hook in the radial direction and is snap-fitted with the outer annular hook.

For example, in the second embodiment shown in FIGS. 4 to 5, the connection housing 5 may comprise a tubular body 54 and a top cover 55 connected to the top of the tubular body 54, and the top cover 55 is centrally provided with a central opening 551. The lampshade connection portion 12 may comprise a connection post 123 extending centrally from the bottom of the lampshade connection portion towards the connection housing 5, and a central through-hole 1231 opening towards the connection housing 5 is formed in the connection post 123. The lampshade 1 may be connected to the connection housing 5 by means of a fastening mechanism 6, and the fastening mechanism 6 comprises a fastener 61. In a state in which the lampshade 1 is connected to the connection housing 5, the connection post 123 may extend to the interior of the connection housing 5 through the central opening 551, and the fastener 61 is fastened into the central through-hole 1231.

Further, the fastening mechanism 6 may further comprise a damping washer 62 with an opening 621, and the damping washer 62 is clamped between a head 611 of the fastener 61 and the connection post 123 and abuts against the top cover 55.

Further, the fastener 61 may be a screw. In particular, the screw may be a self-tapping screw. Alternatively, the connection post 123 may form an internal thread in the central through-hole 1231, and the internal thread is fitted with an external thread of the screw.

Further, the top cover 55 may be connected to the tubular body 54 by means of at least one radial rib.

Further, the connection housing 5 may comprise an annular groove 56 formed on a top surface of the top cover 55 and opening towards the lampshade connection portion 12, and the lampshade connection portion 12 may comprise a guide member 124 extending from the bottom of the lampshade connection portion towards the top cover 55. In a state in which the lampshade 1 is connected to the connection housing 5, the guide member 124 is received into the annular groove 56.

Further, the lampshade connection portion 12 may comprise an inner annular flange 125 extending from the bottom of the lampshade connection portion towards the connection housing 5, and the connection housing 5 may comprise an outer annular flange 57 formed at the top of the tubular body 54 and extending towards the lampshade 1. In a state in which the lampshade 1 is connected to the connection housing 5, the inner annular flange 125 is located on the inner side of the outer annular flange 57 in the radial direction and abuts against the outer annular flange 57 in a shape-fitting manner.

In particular, the driving unit 3 may be arranged in the base 4. Further, a tapered or cylindrical space may be formed in the base 4, and the driving unit 3 is arranged in the space.

Of course, the position arrangement of the driving unit 3 is not limited thereto. For example, the driving unit 3 may be arranged at an interface between the base 4 and the lampshade connection portion 12. Alternatively, the driving unit 3 may be arranged in the lampshade connection portion 12. Further, a tapered or cylindrical space may be formed in the lampshade connection portion 12, and the driving unit 3 is arranged in the space.

The present utility model further provides a bulb group. The bulb group comprises a plurality of rotatable bulbs mentioned above, the rotatable bulbs being rotatable to specific angles respectively as required. For example, the bulb group may be installed in a row, and by rotating the positions of the individual bulbs (e.g., flat bulbs), the row of bulbs can be arranged more regularly or to achieve a specific effect. Alternatively, the bulb group may be installed in a specific shape, and a specific effect is achieved by rotating the bulbs. For example, a plurality of bulbs in the bulb group are enclosed into a circle and rotated to specific angles, such that corresponding light-emitting surfaces or effect surfaces can be seen from each angle.

The above are only the preferred embodiments of the present utility model, and are not intended to limit the present utility model. For those skilled in the art, the present utility model may have various modifications and variations. Any modifications, equivalent replacements, improvements and the like made within the spirit and principle of the present utility model shall fall within the scope of protection of the present utility model.

1. A rotatable bulb, comprising:
a lampshade, the lampshade comprising a lampshade body portion (11) and a lampshade connection portion located at the bottom of the lampshade body portion (11);
a light-emitting element;
a driving unit, the driving unit being electrically connected to the light-emitting element; and
a base, the base being connected to the lampshade connection portion by means of a connection housing for electrically connecting the rotatable bulb to a socket, and the light-emitting element being arranged in an inner space of the lampshade, the connection housing and/or the base,
wherein the connection housing is connected between the lampshade and the base, and the lampshade connection portion is rotatable relative to the connection housing.

2. The rotatable bulb according to claim 1, wherein the lampshade connection portion comprises an inner annular hook formed at the bottom thereof, and the connection housing comprises an outer annular hook formed at the top thereof, wherein in a state in which the lampshade is connected to the connection housing, the inner annular hook is located on the inner or outer side of the outer annular hook in the radial direction and is snap-fitted with the outer annular hook.

3. The rotatable bulb according to claim 2, wherein the lampshade connection portion further comprises a limiting protrusion extending from the bottom of the lampshade connection portion towards the top of the connection housing, and the connection housing further comprises a limiting boss extending from the top of the connection housing, wherein in a state in which the lampshade is connected to the connection housing, the limiting protrusion abuts against the top of the connection housing and the limiting boss abuts against the bottom of the lampshade connection portion.

4. The rotatable bulb according to claim 2, wherein the connection housing further comprises at least one damping adjustment boss formed at the top thereof, the at least one damping adjustment boss is arranged on the inner side of the outer annular hook in the radial direction, and in a state in which the lampshade is connected to the connection housing, the inner annular hook is clamped between the outer annular hook and the at least one damping adjustment boss.

5. The rotatable bulb according to claim 1, wherein the lampshade connection portion comprises an outer annular hook formed at the bottom thereof, and the connection housing comprises an inner annular hook formed at the top thereof, wherein in a state in which the lampshade is connected to the connection housing, the inner annular hook is located on the inner side of the outer annular hook in the radial direction and is snap-fitted with the outer annular hook.

6. The rotatable bulb according to claim 1, wherein
the connection housing comprises a tubular body and a top cover connected to the top of the tubular body, the top cover being centrally provided with a central opening; and
the lampshade connection portion comprises a connection post extending centrally from the bottom of the lampshade connection portion towards the connection housing, a central through-hole opening towards the connection housing being formed in the connection post; and
the lampshade is connected to the connection housing by means of a fastening mechanism, the fastening mechanism comprising a fastener, wherein in a state in which the lampshade is connected to the connection housing, the connection post extends to the interior of the connection housing through the central opening, and the fastener is fastened into the central through-hole.

7. The rotatable bulb according to claim 6, wherein the fastening mechanism further comprises a damping washer with an opening, and the damping washer is clamped between a head of the fastener and the connection post and abuts against the top cover.

8. The rotatable bulb according to claim 6, wherein the fastener is a screw.

9. The rotatable bulb according to claim 8, wherein
the screw is a self-tapping screw; or
the connection post forms an internal thread in the central through-hole, and the internal thread is fitted with an external thread of the screw.

10. The rotatable bulb according to claim 6, wherein the top cover is connected to the tubular body by means of at least one radial rib.

11. The rotatable bulb according to claim 6, wherein
the connection housing comprises an annular groove formed on a top surface of the top cover and opening towards the lampshade connection portion, and
the lampshade connection portion comprises a guide member extending from the bottom of the lampshade connection portion towards the top cover,
wherein in a state in which the lampshade is connected to the connection housing, the guide member is received into the annular groove.

12. The rotatable bulb according to claim 6, wherein the lampshade connection portion comprises an inner annular flange extending from the bottom of the lampshade connection portion towards the connection housing, and the connection housing comprises an outer annular flange formed at the top of the tubular body and extending towards the lampshade, wherein in a state in which the lampshade is connected to the connection housing, the inner annular flange is located on the inner side of the outer annular flange in the radial direction and abuts against the outer annular flange in a shape-fitting manner.

13. The rotatable bulb according to claim 1, wherein the light-emitting element is a filament, and the filament is arranged around the lampshade body portion.

14. The rotatable bulb according to claim 1, wherein the driving unit is arranged in the base.

15. The rotatable bulb according to claim 14, wherein a tapered or cylindrical space is formed in the base, and the driving unit is arranged in the space.

16. The rotatable bulb according to claim 1, wherein the driving unit is arranged at an interface between the base and the lampshade connection portion, the lampshade is in flat shape.

17. The rotatable bulb according to claim 1, wherein the driving unit is arranged in the lampshade connection portion.

18. The rotatable bulb according to claim 17, wherein a tapered or cylindrical space is formed in the lampshade connection portion, and the driving unit is arranged in the space.

19. A bulb group, comprising a plurality of rotatable bulbs according to claim 1, the lampshade is flat shape, the plurality of rotatable bulbs being rotatable to specific angles respectively as required.
